(19) United States
(12) Patent Application Publication
(10) Pub. No.: US 2003/0200353 A1
(43) Pub. Date: Oct. 23, 2003

(54) Browser-implemented upload/download of a driver

(76) Inventors: Vikas Dogra, Lake Forest, CA (US); Manoj K. Verma, Lake Forest, CA (US); Sanjay Wangoo, Lake Forest, CA (US); Ashutosh S. Gijare, Lake Forest, CA (US); George Koppich, Palos Verdes Est., CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/125,886

(22) Filed: Apr. 19, 2002

(51) Int. Cl. G06F 13/10; G06F 9/44

(52) U.S. Cl. 709/321

(57) ABSTRACT

A method of network interaction is disclosed including the steps of providing a thin client user interface for a network and presenting a list of shared devices in the network using the thin client interface. The thin client interface enables a selection of at least one of the shared devices and enables a selection of a device driver to be associated with the least one of the shared devices. The thin client interface also associates a selected device driver with a selected shared device.

### BACKGROUND OF THE INVENTION

The present invention is related to the field of managing document output in a network environment. The present invention has particular applicability to the management of drivers for a variety of different type network printers as used by a plurality of clients using different types of platforms.

In a network where documents are outputted by a printer or other type of document service appliance, documents are typically managed through a document management system in which an interface is used to access appliance system documents. Access is provided to a document management repository, which can be one or more folders on a network server or the like. Network-based document service appliances can include iSP appliances (i.e. image Service Platform appliances), a document distribution solution with document management capabilities and device management support. The iSP appliance enables users to quickly store and retrieve documents from the document repository.

An iSP appliance is implemented in a client/server system and typically includes a Document Distribution Module (DDM). The DDM has a client-server architecture, where the appliance is the server component and all the user machines are the clients. The primary function of the DDM is to route jobs to various types of destinations from virtually any type of client operating system (OS) (e.g., Windows, Unix, Mac, etc.) without requiring a user to have special skills in managing output devices.

Two types of clients are typically available: a “thick client,” a client operating through a printer driver; and a “thin client,” a client operating through a web browser. An appliance may operate a Linux OS. The DDM in turn routes the job to its final destination, and thus the appliance becomes the focal point for monitoring and controlling delivery of these jobs to the respective destinations. The clients offer the capability of saving a particular set of routing options as a profile, and by doing so, simplifies user tasks when submitting jobs with the same options, and to the same destination.

Since the Document Distribution Module provides users with the ability to send documents to network printers, in order to perform this operation, Windows client machines require the respective printer driver in order to generate a print job for a document. This is typically accomplished first by loading the print driver on the print server. As a second step the printer driver can be downloaded from the print server to the client machine. For print servers running on Windows platforms these operations are accomplished via Point and Print (using Windows Explorer and Add Printer Wizard).

### SUMMARY OF THE INVENTION

The deficiencies and drawbacks associated with previous type systems are overcome by the presently disclosed method of network interaction including the steps of providing a thin client user interface for a network and presenting a list of shared devices in the network using the thin client interface. The thin client interface enables a selection of at least one of the shared devices and enables a selection of a device driver to be associated with the least one of the shared devices. The thin client interface also associates a selected device driver with a selected shared device.

As will be realized, the invention is capable of other and different embodiments and its several details are capable of modifications in various respects, all without departing from the invention. Accordingly, the drawing and description are to be regarded as illustrative and not restrictive.

### BRIEF DESCRIPTION OF THE DRAWINGS

FIG. 1 is a diagram illustrating the operations of uploading and downloading a printer driver in accordance with the present invention.

### DETAILED DESCRIPTION OF THE INVENTION

The present invention is directed to a method and implementation of uploading and downloading a driver using a web browser. The invention provides a mechanism for accomplishing the same functionality via the thin client interface (i.e. browser) of an iSP product and for print servers (preferably an iSP print server) running on Linux platforms. The present invention provides a means for browser clients running on Windows platforms to upload and download printer drivers to and from an iSP server running on a Linux platform.

The method and implementation of Browser Upload/Download of Drivers, in accordance with the present invention, provides a mechanism for accomplishing the desired functionality via the thin client interface (Browser) of the iSP product. This functionality helps ISP's thin client interface users with performing the uploading and downloading of drivers from the familiar thin client interface thus saving additional efforts and user inconvenience.

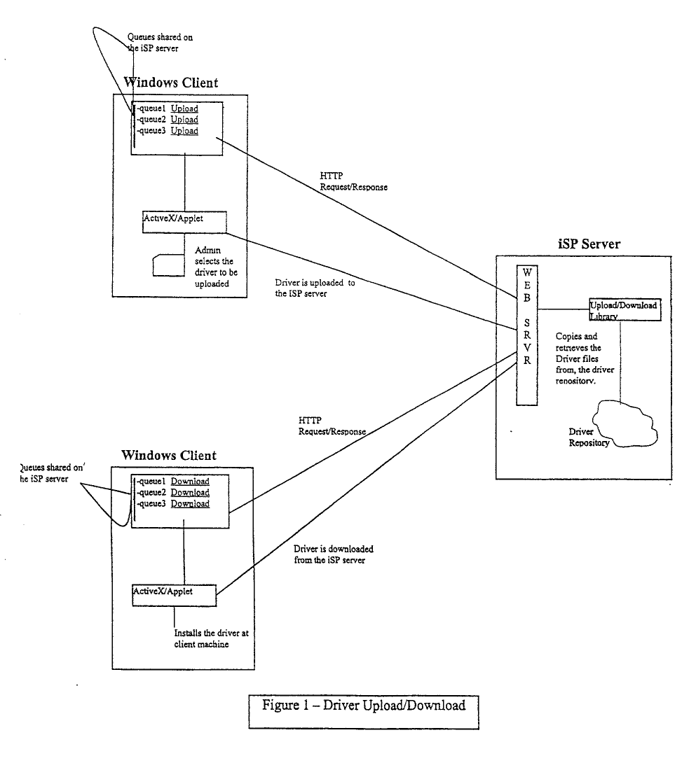

The diagram presented in FIG. 1 illustrates these two distinct operations:

Upload Operation: Through an HTTP Request/Response exchange the iSP Administrator is presented with the list of shared printers (queues) made available by the iSP Server. Next the user selects a queue, and via an ActiveX/Applet selects the driver to be associated with the respective queue. The driver is uploaded to the iSP server and stored. An association is recorded between the respective shared printer and the newly uploaded driver, so that the system will “remember” the driver for future print orders from this client machine.

Download Operation: Through an HTTP Request/Response exchange a user is presented with the list of shared printers (queues) made available by the iSP Server. The user selects the network printer that is desired to be installed on the client machine. The respective driver is downloaded and via an ActiveX/Applet the driver is installed on the client machine.

The ActiveX/Applet component used in the present invention emulates the same functionality as provided by the “Point and Print” feature of Windows apart from communicating with the ISP server. The task of uploading and downloading of drivers will be done in a same fashion as done by Windows which means that operations performed through ISP thin client interface will be valid outside the ISP domain also. For example the driver uploaded through “Point and Print” of Windows would be available for downloading through ISP interface and vice versa.

As described hereinabove, the present invention solves many problems associated with previous type methods and implementations. However, it will be appreciated that various changes in the details, materials and arrangements of parts which have been herein described and illustrated in order to explain the nature of the invention may be made by those skilled in the are within the principle and scope of the invention will be expressed in the appended claims.

We claim:

1. A method of network interaction comprising:
providing a thin client user interface for a network;
presenting a list of shared devices in the network using the thin client interface;
enabling a selection of at least one of the shared devices using the thin client interface;
enabling a selection of a device driver to be associated with the least one of the shared devices using the thin client interface;
associating a selected device driver with a selected shared device using the thin client interface.

2. The method of claim 1 wherein, following the step of associating, further comprising a step of uploading and storing the selected device driver to a server.

3. The method of claim 1 further comprising a step of recording the association between the selected shared device and the selected device driver so that the network will use the selected device driver for subsequent operations of the selected shared device originating from a respective machine utilizing the thin client interface.

4. The method of claim 1 wherein the thin client interface is a web browser.

5. The method of claim 1 wherein the list of shared network devices is made available by a network server.

6. The method of claim 1 wherein the shared devices are respective printer queues.

7. The method of claim 1 wherein the selection of the device driver to be associated is performed using an ActiveX/Applet.

8. The method of claim 1 wherein the step of presenting a list is performed by an network administrator through an HTTP Request/Response exchange.

9. The method of claim 1 wherein, following the step of associating, further comprising a step of downloading and storing the selected device driver to a client machine.

10. The method of claim 9 wherein the respective device driver is downloaded and installed on the client machine via an ActiveX/Applet.
